(19) United States
(12) Patent Application Publication
(10) Pub. No.: US 2016/0344657 A1
(43) Pub. Date: Nov. 24, 2016

(54) PROVIDING PERFORMANCE ALTERNATIVES BASED ON COMPARATIVE PRICE AND PERFORMANCE DATA OF A RUNNING SaaS INSTANCE

(71) Applicant: International Business Machines Corporation, Armonk, NY (US)

(72) Inventors: David N. Nguyen, Research Triangle Park, NC (US); Johnny Meng-Han Shieh, Austin, TX (US); Cynthia D. Swessel-Hofer, Rochester, MN (US)

(73) Assignee: International Business Machines Corporation, Armonk, NY (US)

(21) Appl. No.: 14/716,946

(22) Filed: May 20, 2015

(51) Int. Cl. H04L 12/911; H04L 12/26; H04L 12/24; H04L 29/08

(52) U.S. Cl. CPC H04L 47/822; H04L 67/10; H04L 43/0805; H04L 41/5003

(57) ABSTRACT

Embodiments of the invention relate to a primary system instance to operate as a foreground process and creation of one or more shadow system instances to operate as a background process. The background instances yield information and performance data. Performance data associated with the foreground and background processes are generated and compared. One of the background instances may be converted to a new primary system instance as an alternative instance configuration.

### BACKGROUND

The present embodiment(s) described below relates to associating virtual machine (VM) performance with VM configuration. More specifically, the embodiment(s) relates to evaluating Software as a Service (SaaS) instances using shadow system configurations.

The cloud computing environment refers to delivery of hosted services over the Internet. There are different classifications of cloud computing, including private, public, and hybrid. Private cloud services pertain to services delivered from an internal data center to one or more internal user and preserves management, control and security. Public cloud services relate to a third party delivering the service over the Internet. Hybrid cloud services pertain to a combination of public and private cloud services. More specifically, in the hybrid configuration, an organization provides and manages some resources in-house and has others provided externally. For example, an organization might use a public cloud service for archived data but continue to maintain in-house storage for operational customer data. This hybrid approach allows an organization to take advantage of scalability and cost effectiveness that a public cloud computing environment offers without exposing internal or confidential applications and data.

Information technology infrastructure is defined by computational maximums or limits. In the case where an internal infrastructure is physically insufficient to handle a job, the functionality and ability may be outsourced to a third party with external cloud capacity. More specifically, external hardware available through a third party may be engaged over the Internet to support capacity requirements.

### SUMMARY

The invention includes a method, system, and computer program product for performance analysis of one or more system instances.

An application executes in the foreground as a primary system instance. In addition, a first system instance is provided with a first configuration and a second system instance is provided as a second configuration. The application executes as a background process on both with the first and second system instances. Performance data is generated for each system instance. More specifically, first performance data is generated for the first system instance and second performance data is generated for the second system instance. The first and second performance data are stored at a first location and a second location, respectively. The first and second performance data are compared and one of the first and second system instances is selected in response to the comparison. More specifically, the selected system instance is converted to a new primary configuration, so that the application may be executed with the new primary system associated with the converted configuration.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments of the invention, and not of all embodiments of the invention unless otherwise explicitly indicated.

FIG. 1 depicts a block diagram of a cloud computing node according to an embodiment.

FIG. 2 depicts a block diagram of a cloud computing environment according to an embodiment.

FIG. 3 depicts a block diagram illustrating abstraction model layers.

FIG. 4 depicts a block diagram illustrating an external cloud deploying one or more shadow configuration systems.

FIG. 5 depicts a flow chart illustrating a process for generating data to compare performance and price data between a primary set consisting of a virtual machine and/or shadow container, and at least one secondary set consisting of a virtual machine and/or shadow container.

FIG. 6 depicts a flow chart illustrating a process to compare performance and price data generated by the visible virtual machine and shadow container with alternatively configured systems.

FIG. 7 depicts a flow chart illustrating a process for converting an alternative virtual machine or container configuration to a primary configuration.

FIG. 8 depicts a block diagram illustrating a computer system for operating both a virtual machine and a container.

FIG. 9 depicts a block diagram of a report.

FIG. 10 depicts a block diagram showing a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

Software as a Service (SaaS) is a software distribution model in which applications are hosted by a vendor or service provider and made available to customers over a network, such as the Internet. SaaS is closely related to the application service provider (ASP) and on demand computing, including hosted application management model(s) and software on demand model(s). The hosted application management model is where a provider hosts software for a customer and delivers the service over the Internet. The software on demand model is where the provider gives customers network based access to a single copy of an application created specifically for SaaS distribution. An entity faced with a large and frequent data analysis requirement may choose to contract with a SaaS provider, also referred to herein as outsourcing.

Performing services internally has a cost, specifically, the cost of utilizing specific resources. At the same time, outsourcing of services has an explicit cost, namely a fee from the service provider providing the outsourced services. In some cases, the fees of the outsourced provider may be static, and in one embodiment, the fees may be dynamic and subject to change based on various factors. For example, use of the outsourced services may be subject to change based on the time of day when the services are performed, recognizing that there may be an increased demand during business hours and having the fees reflect the changes in demand.

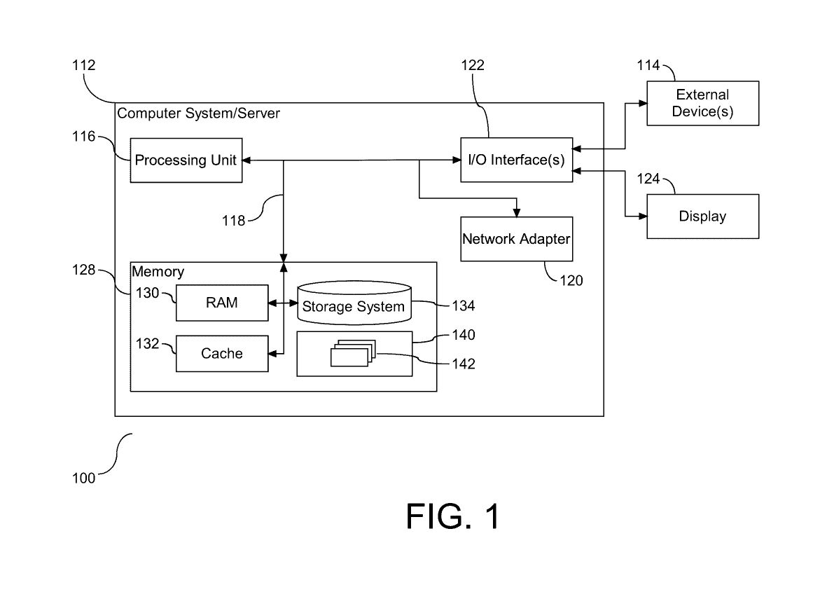

Services may be outsourced to a cloud computing environment, essentially utilizing hardware of an external system and associated resources. The cloud computing environment is service oriented with a focus on statelessness, low coupling, modularity, and semantic interoperability. At the heart of cloud computing is an infrastructure comprising a network of interconnected nodes. Referring now to FIG. 1, a schematic of an example of a cloud computing node is shown. Cloud computing node (110) is only one example of a suitable cloud computing node and is not intended to suggest any limitation as to the scope of use or functionality of embodiments of the invention described herein. Regardless, cloud computing node (110) is capable of being implemented and/or performing any of the functionality set forth hereinabove. In cloud computing node (110) there is a computer system/server (112), which is operational with numerous other general purpose or special purpose computing system environments or configurations. Examples of well-known computing systems, environments, and/or configurations that may be suitable for use with computer system/server (112) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server (112) may be described in the general context of computer system-executable instructions, such as program modules, being executed by a computer system. Generally, program modules may include routines, programs, objects, components, logic, data structures, and so on that perform particular tasks or implement particular abstract data types. Computer system/server (112) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server (112) in cloud computing node (110) is shown in the form of a general-purpose computing device. The components of computer system/server (112) may include, but are not limited to, one or more processors or processing units (116), a system memory (128), and a bus (118) that couples various system components including system memory (128) to processor (116). Bus (118) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server (112) typically includes a variety of computer system readable media. Such media may be any available media that is accessible by computer system/server (112), and it includes both volatile and non-volatile media, removable and non-removable media.

System memory (128) can include computer system readable media in the form of volatile memory, such as random access memory (RAM) (130) and/or cache memory (132). Computer system/server (112) may further include other removable/non-removable, volatile/non-volatile computer system storage media. By way of example only, storage system (134) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (118) by one or more data media interfaces. As will be further depicted and described below, memory (128) may include at least one program product having a set (e.g., at least one) of program modules that are configured to carry out the functions of embodiments of the invention.

Program/utility (140), having a set (at least one) of program modules (142), may be stored in memory (128) by way of example, and not limitation, as well as an operating system, one or more application programs, other program modules, and program data. Each of the operating systems, one or more application programs, other program modules, and program data or some combination thereof, may include an implementation of a networking environment. Program modules (142) generally carry out the functions and/or methodologies of embodiments of the invention as described herein.

Computer system/server (112) may also communicate with one or more external devices (114), such as a keyboard, a pointing device, a display (124), etc.; one or more devices that enable a user to interact with computer system/server (112); and/or any devices (e.g., network card, modem, etc.) that enable computer system/server (112) to communicate with one or more other computing devices. Such communication can occur via Input/Output (I/O) interfaces (122). Still yet, computer system/server (112) can communicate with one or more networks such as a local area network (LAN), a general wide area network (WAN), and/or a public network (e.g., the Internet) via network adapter (120). As depicted, network adapter (120) communicates with the other components of computer system/server (112) via bus (118). It should be understood that although not shown, other hardware and/or software components could be used in conjunction with computer system/server (112). Examples, include, but are not limited to: microcode, device drivers, redundant processing units, external disk drive arrays, RAID systems, tape drives, and data archival storage systems, etc.

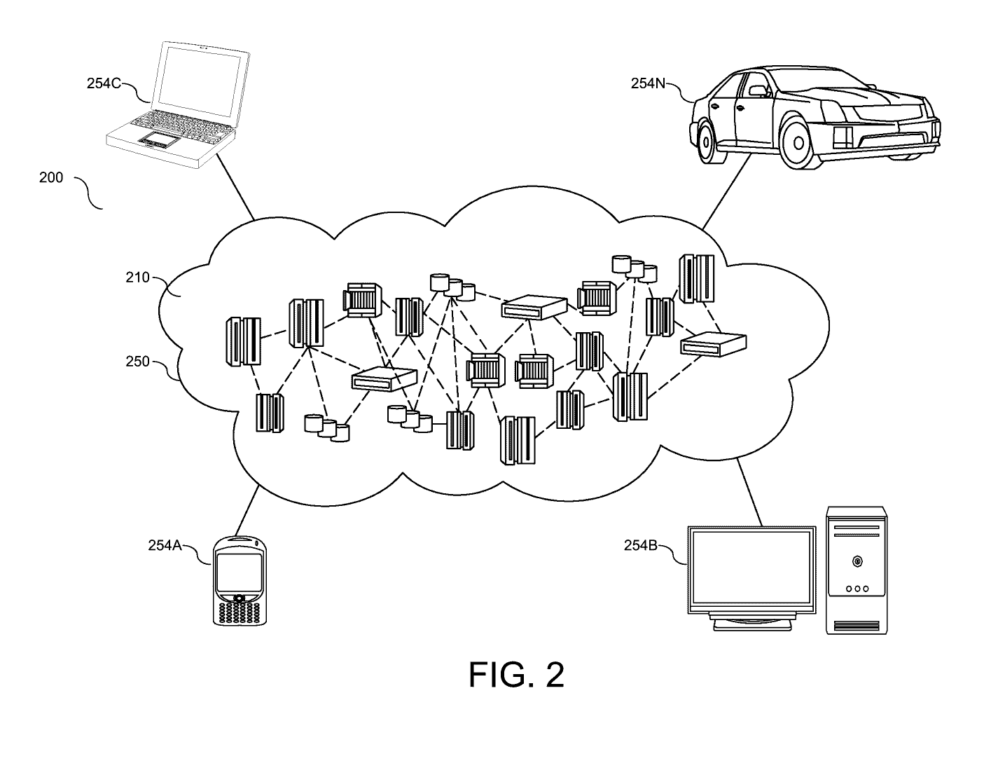

Referring now to FIG. 2, illustrative cloud computing environment (250) is depicted. As shown, cloud computing environment (250) comprises one or more cloud computing nodes (210) with which local computing devices used by cloud consumers, such as, for example, personal digital assistant (PDA) or cellular telephone (254A), desktop computer (254B), laptop computer (254C), and/or automobile computer system (254N) may communicate. Nodes (210) may communicate with one another. They may be grouped (not shown) physically or virtually, in one or more networks, such as Private, Community, Public, or Hybrid clouds as described hereinabove, or a combination thereof. This allows cloud computing environment (250) to offer infrastructure, platforms and/or software as services for which a cloud consumer does not need to maintain resources on a local computing device. It is understood that the types of computing devices (254A)-(254N) shown in FIG. 2 are intended to be illustrative only and that computing nodes (210) and cloud computing environment (250) can communicate with any type of computerized device over any type of network and/or network addressable connection (e.g., using a web browser).

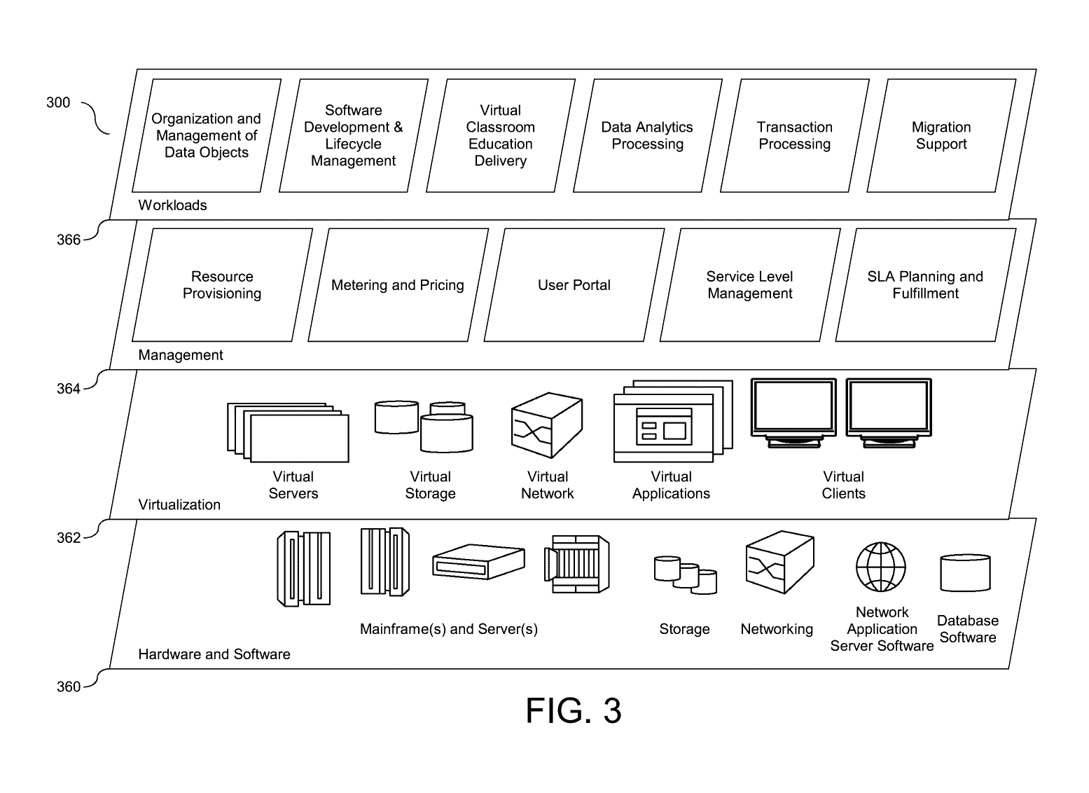

Referring now to FIG. 3, a set of functional abstraction layers (300) provided by cloud computing environment (250) is shown. It should be understood in advance that the components, layers, and functions shown in FIG. 3 are intended to be illustrative only and embodiments of the invention are not limited thereto. As depicted, the following layers and corresponding functions are provided: hardware and software layer (360), virtualization layer (362), management layer (364), and workload layer (366). The hardware and software layer (360) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (362) provides an abstraction layer from which the following examples of virtual entities may be provided: virtual servers; virtual storage; virtual networks, including virtual private networks; virtual applications and operating systems; and virtual clients.

In one example, management layer (364) may provide the following functions: resource provisioning, metering and pricing, user portal, service level management, and SLA planning and fulfillment. The functions are described below. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer (366) provides examples of functionality for which the cloud computing environment may be utilized. Examples of workloads and functions which may be provided from this layer includes, but is not limited to: mapping and navigation; software development and lifecycle management; virtual classroom education delivery; data analytics processing; operation processing; and maintenance of consistent application data to support migration within the cloud computing environment.

In the shared pool of configurable computer resources described herein, hereinafter referred to as a cloud computing environment, applications may be processed by different entities and under different system parameters. For example, an application may be processed in a virtual machine environment or a container environment, each referred to as a system instance, which although similar have differing physical parameters. At the same time, each virtual machine or container may be separately configured, with each configuration utilizing different physical machine hardware. Differences in configuration and hardware of the system instances may have different costs. Selection of one system instance over another may affect the cost of application processing. Accordingly, by operating different system configurations as background operations, an optimal system environment may be selected for future application processing.

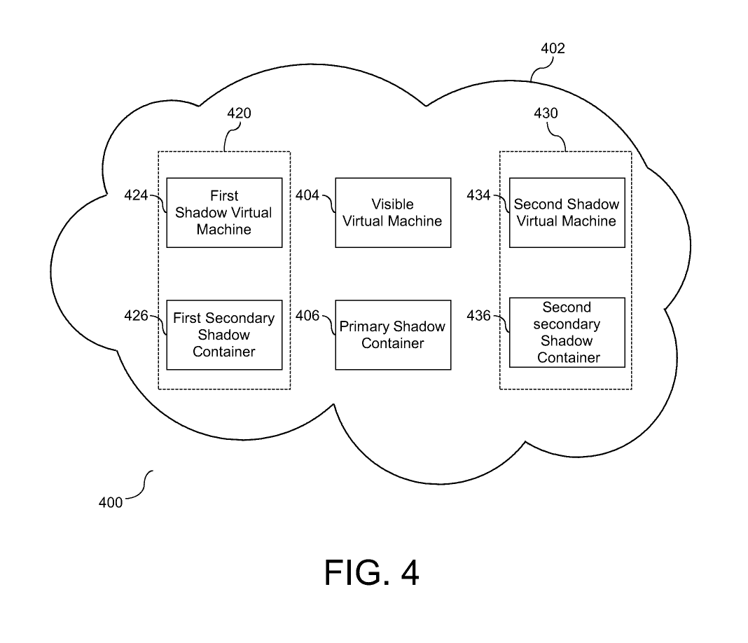

Referring to FIG. 4, a block diagram (400) is provided illustrating an external cloud deploying one or more shadow configuration systems. An external cloud (402) is provided to illustrate provision of services by a third party. Namely, the cloud (402) is accessible to users across the Internet, and is available to provide select services to requesting users who are provided access to the cloud (402). In one embodiment, the external cloud (402) is employed to satisfy processing requirements not met by internal processing capacity, such as through an internal cloud. As shown herein, the external cloud (402) includes a visible virtual machine (404) configured and/or created to support the processing specifications of the third party. The virtual machine (404) is a software configuration that runs an operating system and application. More specifically, the virtual machine (404) is comprised of a set of specification and configuration files and is backed by one or more physical resources of an associated host. A container is an alternate configuration to the virtual machine with software that acts as a parent program to hold and execute a set of commands to run other software routines. Similar to the virtual machine, the container is comprised of a set of specification and configuration files and is backed by one or more physical resources of an associated host. A primary shadow container (406) is created in the external cloud (402) in response to the creation and/or availability of the visible virtual machine (404). In one embodiment, the roles of the virtual machine (404) and the container (406) may be reversed with the virtual machine (404) functioning as a shadow to the container (406).

In the example shown herein, the primary shadow container (406) is provided in the external cloud (402) to mimic or imitate the functionality of the visible virtual machine (404). The primary shadow container (406) is configured to reflect the parameters of the visible virtual machine (404) within the confines and parameters of a container configuration. At the same time, at least one set of secondary entities, also referred to as shadow systems, are created. In one embodiment, the quantity of secondary entities may be increased. For descriptive purposed, two sets of secondary entities are shown and described. In relation to the illustration provided, first and second sets of entities, (420) and (430), respectively, are provided and identified.

The first set (420) includes a first shadow virtual machine (424) and a first secondary shadow container (426). The first shadow virtual machine (424) and first secondary shadow container (426) of the first set (420) reflect a specified decrease in supporting hardware. In one embodiment, the container and virtual machine of the first set (420) processes an application at a 25% decrease in hardware resources. For example, in one embodiment, the specified decrease of the first set (420) represents a virtual machine and container that are smaller in processing speed, RAM, and/or storage in comparison to the visible virtual machine (404) and the primary shadow container (406). The second set (430) includes a second shadow virtual machine (434) and a second secondary shadow container (436). In one embodiment, the container and virtual machine of the second set (430) processes an application at a 25% increase in hardware resources. The second shadow virtual machine (434) and second secondary shadow container (436) of the second set (430) reflect a specified increase in supporting hardware, including but not limited to a specified increase in processing speed, RAM, and/or storage in comparison to the visible virtual machine (404). The quantity of secondary shadow containers and shadow virtual machines shown herein should not be considered limiting. In one embodiment, there may be a minimum of one shadow container or virtual machine. Regardless of the quantity of shadow containers and virtual machines, each shadow container or virtual machine functions to mimic or imitate the functionality of the visible virtual machine (404) and primary shadow container (406), with each second set of entities (420) and (430) representing a different configuration. Accordingly, the sets of secondary containers and virtual machines (420) and (430), respectively, demonstrate a shadow system deployed in the external cloud (402) associated with the visible virtual machine (404) and the primary shadow container (406).

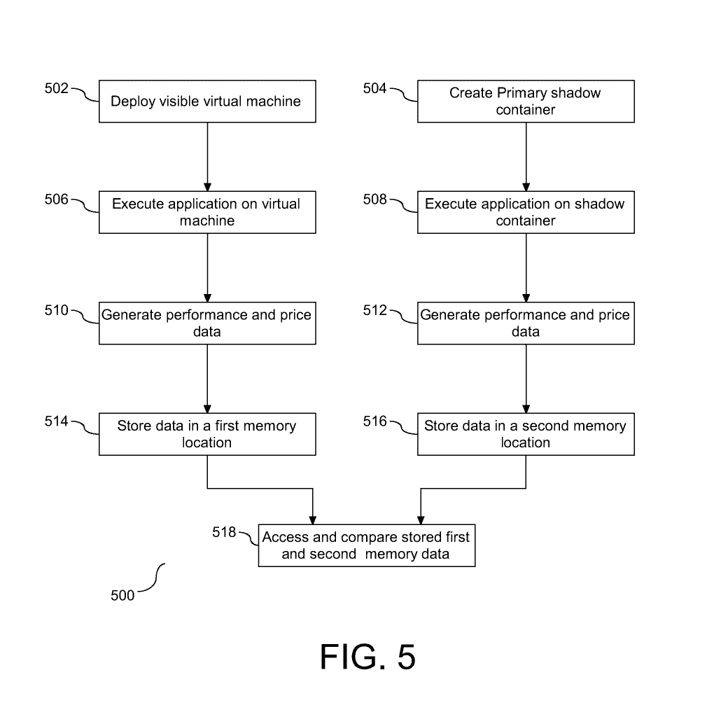

Referring to FIG. 5, a flow chart (500) is provided illustrating a process for generating data to compare performance and price data between a primary set consisting of a virtual machine and/or a shadow container, and at least one secondary set consisting of a virtual machine and/or a shadow container. Shadow systems, as shown and described herein, include a shadow virtual machine and/or shadow container, with the functionality of the shadow system to mimic the actions of the visible virtual machine (404) and/or primary shadow container (406). Based on the configuration of the primary system and secondary systems shown and described in FIG. 4, a visible virtual machine is deployed with a first configuration (502), and a primary shadow container is created with a configuration reflecting the configuration of the visible virtual machine (504). In one embodiment, the primary shadow container is created (504) with a configuration that reflects deploying the visible virtual machine (502), as leased by a user from an external provider. Accordingly, deploying both the virtual machines and associated shadow containers with the similar configurations enables monitoring of both visible and shadow systems.

The visible virtual machine executes an application (506), and the primary shadow container executes the same application (508). In one embodiment, both the visible virtual machine and the primary shadow container accept input from a user's internal cloud and execute the application under the respective configurations, e.g. virtual machine and container. In one embodiment, the application is an SaaS instance. The visible virtual machine may execute the application (506) in parallel to the primary shadow container executing the application (508). Alternatively, the visible virtual machine may execute the application (506) prior to the primary shadow container executing the application (508). The order of executing the application by the visible virtual machine and the primary shadow container is for exemplary purposes and is not considered to be limiting.

Performance and price data associated with executing the application on the visible virtual machine is generated (510). Similarly, performance and price data associated with executing the application on the primary shadow container is generated (512). In one embodiment, performance data comprises CPU utilization. Performance data may also comprise I/O rates or disk usage. Also, the performance data may comprise an execution time threshold. The performance and price data associated with the visible virtual machine that results from the executed application may be returned to the user. In one embodiment, the performance and price data associated with the primary shadow container are written to a null pipe to avoid confusing the user. Accordingly, performance and price data are generated for a plurality of sets of virtual machines and associated shadow containers, including at least a visible virtual machine and a primary shadow container, executing the same application.

The performance and price data associated with the virtual machine is stored in a first memory location (514). Similarly, the performance and price data associated with the primary shadow container is stored in a second memory location (516). Following storage of the data, sets of data may be accessed and compared. In one embodiment, data generated by the visible virtual machine is accessed and compared to data generated by the primary shadow container (518). Accordingly, performance between a virtual machine and a similarly configured container may be evaluated so that an optimal configuration may be selected for future application processing.

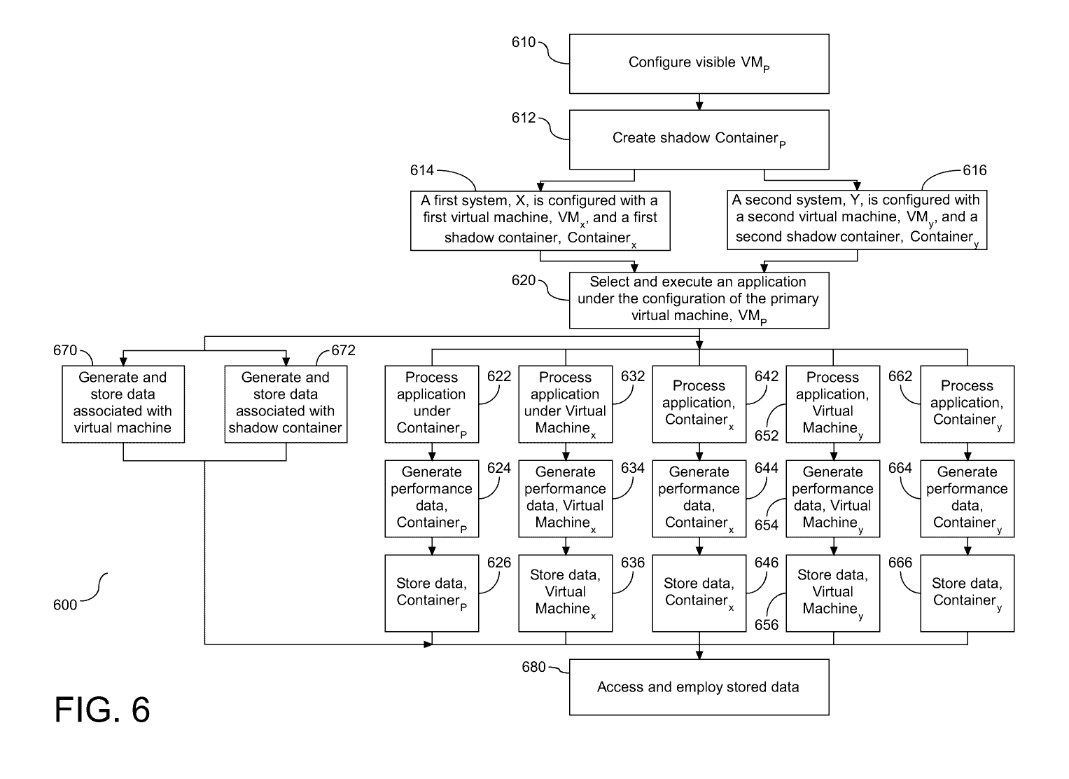

Referring to FIG. 6, a flow chart (600) is provided illustrating a process to compare performance and price data generated by the visible virtual machine and shadow container with alternatively configured systems. More specifically, the alternative systems are created to simulate operation under different system configurations. A primary virtual machine, VM_{P}, is configured (610) and a shadow container, container_{P}, with similar characteristics to VM_{P} is created (612). As such, the virtual machine and container created at steps (610) and (612) are similarly configured. In addition, two sets of alternatively configured systems are created. As shown, a first system X is configured with a first virtual machine, VM_{X}, and a first shadow container, container_{X}, (614), and a second system Y is configured with a second virtual machine, VM_{Y}, and a second shadow container, container_{Y}, (616). An application is selected and executes under the configuration of the primary virtual machine, VM_{P} (620). In parallel or sequential to the execution of the application at step (620), the application is also processed as a background process in the shadow container, container_{P}, and each of the alternatively configured system.

Data associated with execution and processing of the application on the visible virtual machine is generated and stored (670), and data associated with execution and processing of the application on the shadow container is generated and stored (672). In one embodiment, the data at steps (670) and (672) may be stored at separate memory locations. Each configured background system also executes the application, and associated processing data for each configuration is generated and stored. As shown, two alternative system configurations are provided, with each system including a virtual machine and a shadow container. The application is shown processing in the background under container_{P} (622), virtual machine_{X} (632), container_{X} (642), virtual machine_{Y} (652), and container_{Y} (662). In one embodiment, additionally configured systems are provided, and the application is processed in the background for each additionally configured system. Performance data for container_{P} is generated (624) and stored (626), performance data for VM_{X} is generated (634) and stored (636), performance data for container_{X} is generated (644) and stored (646), performance data for VM_{Y} is generated (654) and stored (656), and performance data for container_{Y} is generated (664) and stored (666). In one embodiment, data for each virtual machine and each container operating in the background is separately stored in a different memory location and is separately accessible. After the data is stored, data from any or each of the background application processes may be accessed and employed (680) for evaluation of the operating efficiency of the application under different system parameters.

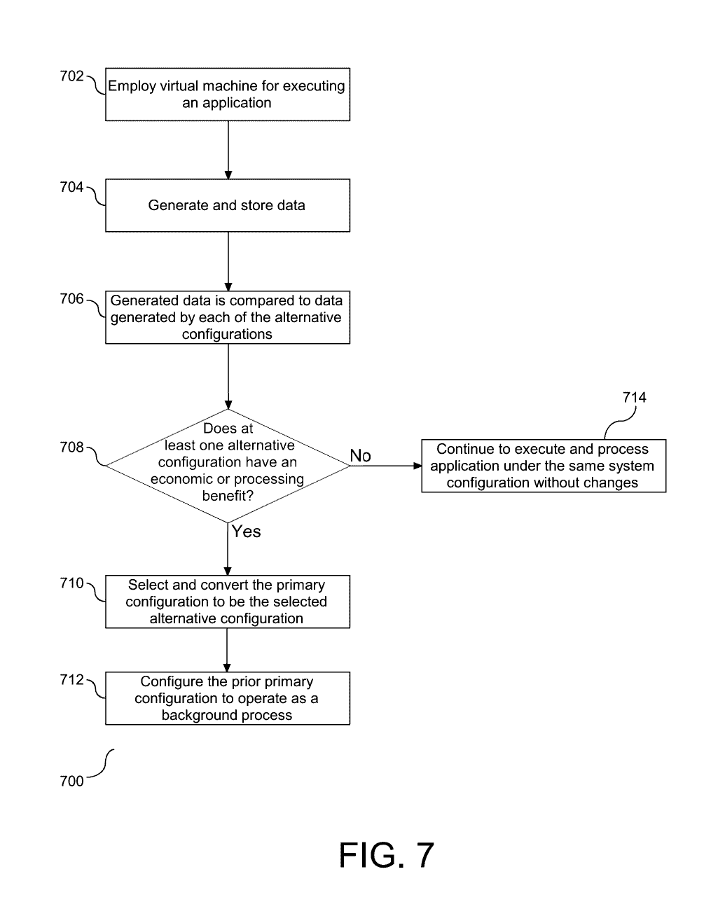

Once the generated data is stored, the data may be utilized for comparison to the performance and price data generated by the visible virtual machine. As presented in FIG. 2, performance and price data generated by the visible virtual machine while executing an application are compared to performance and price data generated by a primary shadow container while executing the same application. As presented in FIG. 6, four alternative comparisons are employed. With reference to FIG. 7, a flow chart (700) is provided illustrating a process for converting an alternative virtual machine or container configuration to a primary configuration. A virtual machine or container configuration is employed for executing an application (702). At the same time, data from the alternative configurations, as shown and described in FIG. 6, is generated and stored (704). Data generated at step (702) is compared to data generated by each of the alternative configurations (706). The comparison provides information about service performance and price, which could be offered by one or more of the alternatively configured virtual machine(s) and/or container(s). In one embodiment, performance and price data may be presented to the user in tabular form comparing performance between each virtual machine and shadow system configuration. Accordingly, for each configuration, data is collected and stored and employed for comparison.

Following step (706), it is determined if at least one of the alternative configurations has an economic or processing benefit to the primary form of the application execution (708). The determination at step (708) is an evaluation to automatically change the processing environment to one of the alternatively configured systems. The processing benefit may come in different forms. One example of a processing benefit is a faster completion of the application execution. Another example is an increased efficiency associated with the application execution, which may maximize resources. For example an prior job may have required two cores for execution, while a new alternative configuration may only require one core, leaving the non-used core available for a different job execution. The processing benefit may also be expressed as a physical benefit in the form of reduced energy usage with lower operating costs. The processing benefit may also be expressed in the form of a sequential benefit. For example, if a second application depends on completion of a first application, and the first application finished sooner based on time improvement, the second application can also have an earlier start and likely an earlier completion. Application processing that completes earlier may also open up physical configuration and resources for other applications, thereby benefiting a hosting service. In one embodiment, two applications are set for sequential processing wherein the same physical system could dynamically be re-configured for the second application, which in one embodiment has different efficiency requirements than the first application. Accordingly, the processing benefits may take on different forms, and in one embodiment, may be expanded to forms that are not explicitly identified herein.

The determination at step (708) is an evaluation to automatically change the processing environment to one of the alternatively configured systems. In one embodiment, the comparison data must exceed a threshold value. A positive response to the determination at step (708) is followed by selecting one of the alternative configurations and converting the primary configuration to the selected alternative configuration for application processing (710). In addition, the prior primary configuration may be configured to operate as a background process (712). A negative response to the determination at step (708) is followed by the application continuing to execute and process under the same system configuration without any changes. (714). In one embodiment, the evaluation shown and described herein may take place on a periodic basis, or after each application completes execution. Regardless of the period for evaluation, any one of the secondary executing environments may be selected to replace the primary execution environment.

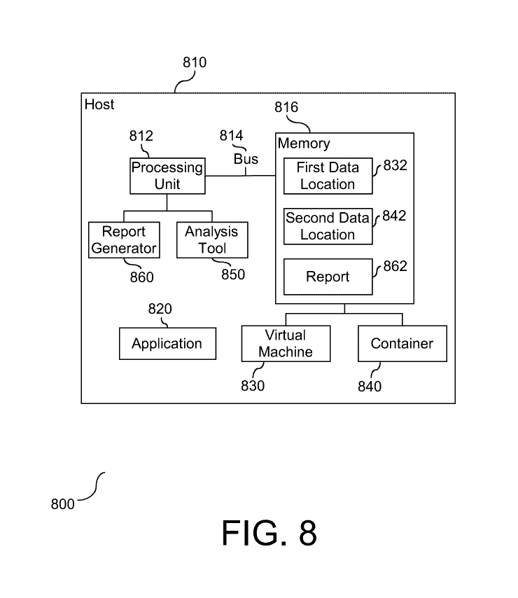

Referring now to FIG. 8, a block diagram (800) of a computer system for operating both a virtual machine and a container is provided. As shown, a computer (810), also referred to herein as a host, is provided with a processing unit (812) operatively coupled to memory (816) across a bus (814). An application (820) is provided for execution by the processing unit (812). Two environments are provided for processing the application, including a virtual machine (830) and a container (840). In one embodiment, the virtual machine (830) and container (840) are similarly configured. Processing of the application (820) takes place on both the virtual machine (830) and the container (840). In one embodiment, the virtual machine (830) is employed as the primary executing environment, and the container (840) operates in the background. Alternatively, the container (840) may be employed as the primary executing environment, and the virtual machine (830) may operate in the background. As shown herein, the memory (816) is partitioned into separate data locations for each executing environment. More specifically, in the example shown herein there are two executing environments, and two associated memory locations for storing execution data. Namely, the data locations include a first data location (832) and a second data location (842). Data associated with execution of the application in the virtual machine environment (830) is stored in the first memory location (832) and data associated with execution of the application in the container environment (840) is stored in the second memory location.

As shown and described above, the generated data may be accessed and evaluated for selection of an appropriate processing environment. An analyzer (850) is shown operating coupled to the processing unit (812). The analyzer (850) functions to analyze operating efficiency of the executing application and to support comparison of the data, and in one embodiment, to generate one or more reports associated with the generated data. The analyzer (850) provides analysis with respect to container configuration, performance, price, and any combination of resource management variables. In one embodiment, performance data includes processor utilization. Performance data may also include I/O rates or disk usage. Also, the performance data may include an execution time threshold. The analyzer (850) may correlate container configuration and application execution performance. The analyzer (850) may also correlate container configuration to price. The type of analysis and the type of variables described herein are not meant to be limiting and are provided for exemplary purposes. The analyzer (850) compares performance and price data to the executing form of the application to each background process of the application that is executing, and in one embodiment, may select one of the alternative configuration environments as a replacement to the primary configuration. Accordingly, the analysis and actions provided by the processing unit (812) and the analysis tool (850) supports subsequently executing an instance of an application on a converted configuration.

Performance and price data may be reviewed and analyzed to evaluate alternative configurations of containers and/or virtual machines. If threshold values are established for either performance or price, the alternative configurations may be evaluated to determine if they satisfy the threshold values. The analysis discussed above may be run dynamically and without human interaction. Indeed, data may be received and analyzed in the form of a generated report. To that end, the analyzer (850) is shown in communication with a report generator (860). The report generator (860) consolidates analysis performed by the analyzer (850) into a deliverable format. In one embodiment, the consolidated analysis comprises a report (862), which is shown stored in memory (816). The report (862) may be sent to, for instance, a requester, an administrator, or other system evaluator. A container configuration change may be authorized in view of the provided analysis of the visible and shadow container systems.

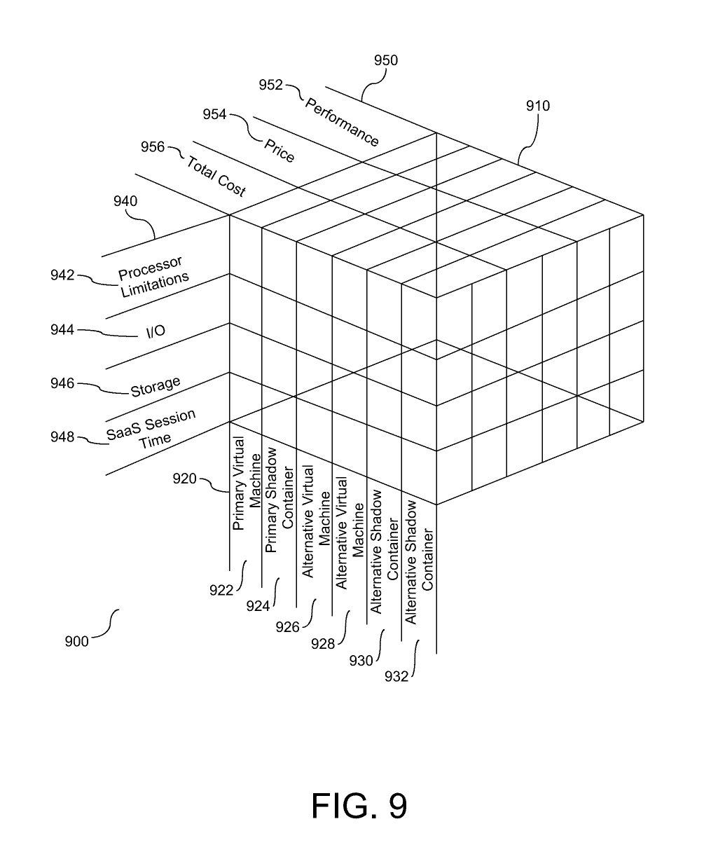

Referring now to FIG. 9, a block diagram (900) of a report is shown. The tabular report is presented for exemplary purposes and is not meant to be limiting. More specifically, the report is shown as a matrix (910) of system configurations and associated data. In the example shown herein, the matrix (910) has three dimensions, including a first dimension (920), a second dimension (940), and a third dimension (950). The first dimension (920) represents system configurations, such as virtual machines and containers. In the example shown herein, there is a primary virtual machine (922), a primary shadow container (924), and two alternative virtual machines (926) and (928) and two alternative shadow containers (930) and (932). The second dimension (940) represents the configuration aspects of each system. As shown herein, there are multiple aspects to the system parameters, including processor limitations (942), I/O (944), storage (946), and SaaS session time (948). Each of these limitations (942)-(948) represents data associated with processing an application in each system environment under associated physical parameters is shown and presented in the third dimension (950), which mainly includes configuration performance (952) and price (954). In one embodiment, the third dimension (950) identifies the total cost (956).

The matrix and associated system configuration parameters is provided for exemplary purposes and is not meant to be limiting. In one embodiment, a report is generated and reviewed to compare container and virtual machine configurations in view of performance and cost. Further, the report may indicate whether certain configurations meet or exceed threshold values. In view of the data presented with the associated container and virtual machine configurations, an externally provided container configuration may be pre-selected for subsequent application execution. Accordingly, comparative analysis is provided and supported so that informed decisions about employing external cloud containers and optimal configurations for the employed containers may take place.

The host described above in FIG. 8 has been labeled with tools in the form of an analyzer (850) and a report generator (860). The tools may be implemented in programmable hardware devices such as field programmable gate arrays, programmable array logic, programmable logic devices, or the like. The tools may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of the tools need not be physically located together, but may comprise disparate instructions stored in different locations which, when joined logically together, comprise the tools and achieve the stated purpose of the tool.

Indeed, executable code could be a single instruction, or many instructions, and may even be distributed over several different code segments, among different applications, and across several memory devices. Similarly, operational data may be identified and illustrated herein within the tool, and may be embodied in any suitable form and organized within any suitable type of data structure. The operational data may be collected as a single data set, or may be distributed over different locations including over different storage devices, and may exist, at least partially, as electronic signals on a system or network.

Furthermore, the described features, structures, or characteristics may be combined in any suitable manner in one or more embodiments. In the following description, numerous specific details are provided, such as examples of agents, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

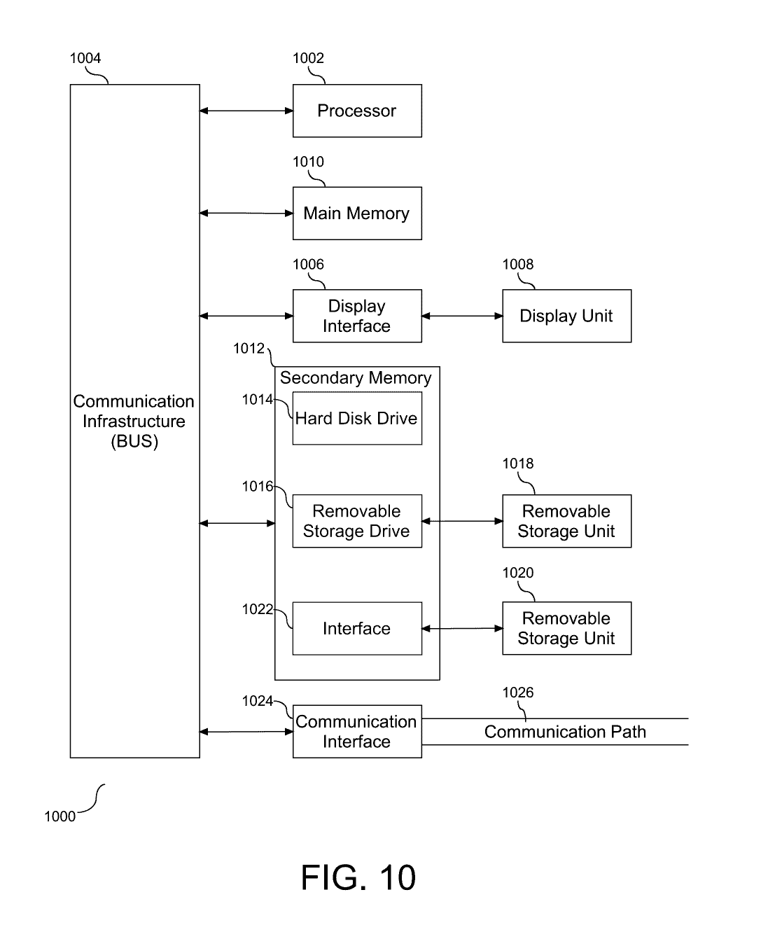

Referring now to the block diagram of FIG. 10, additional details are now described with respect to implementing an embodiment of the present invention. The computer system includes one or more processors, such as a processor (1002). The processor (1002) is connected to a communication infrastructure (1004) (e.g., a communications bus, cross-over bar, or network).

The computer system can include a display interface (1006) that forwards graphics, text, and other data from the communication infrastructure (1004) (or from a frame buffer not shown) for display on a display unit (1008). The computer system also includes a main memory (1010), preferably random access memory (RAM), and may also include a secondary memory (1012). The secondary memory (1012) may include, for example, a hard disk drive (1014) and/or a removable storage drive (1016), representing, for example, a floppy disk drive, a magnetic tape drive, or an optical disk drive. The removable storage drive (1016) reads from and/or writes to a removable storage unit (1018) in a manner well known to those having ordinary skill in the art. Removable storage unit (1018) represents, for example, a floppy disk, a compact disc, a magnetic tape, or an optical disk, etc., which is read by and written to by removable storage drive (1016).

In alternative embodiments, the secondary memory (1012) may include other similar means for allowing computer programs or other instructions to be loaded into the computer system. Such means may include, for example, a removable storage unit (1020) and an interface (1022). Examples of such means may include a program package and package interface (such as that found in video game devices), a removable memory chip (such as an EPROM, or PROM) and associated socket, and other removable storage units (1020) and interfaces (1022) which allow software and data to be transferred from the removable storage unit (1020) to the computer system.

The computer system may also include a communications interface (1024). Communications interface (1024) allows software and data to be transferred between the computer system and external devices. Examples of communications interface (1024) may include a modem, a network interface (such as an Ethernet card), a communications port, or a PCMCIA slot and card, etc. Software and data transferred via communications interface (1024) is in the form of signals which may be, for example, electronic, electromagnetic, optical, or other signals capable of being received by communications interface (1024). These signals are provided to communications interface (1024) via a communications path (i.e., channel) (1026). This communications path (1026) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (1010) and secondary memory (1012), removable storage drive (1016), and a hard disk installed in hard disk drive (1014).

Computer programs (also called computer control logic) are stored in main memory (1010) and/or secondary memory (1012). Computer programs may also be received via a communication interface (1024). Such computer programs, when run, enable the computer system to perform the features of the present invention as discussed herein. In particular, the computer programs, when run, enable the processor (1002) to perform the features of the computer system. Accordingly, such computer programs represent controllers of the computer system.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Alternative system configurations are provided to operate in the background, and more specifically, to execute an application in the background. Data associated with application processing is generated and stored. Analysis of the data enables one of the alternative configurations to be selected as a primary processing environment for the application. Accordingly, an optimal processing environment is selected based on analysis of data gathered from alternative configurations processing the application in the background.

It will be appreciated that, although specific embodiments of the invention have been described herein for purposes of illustration, various modifications may be made without departing from the spirit and scope of the invention. In particular, comparison of data from the background execution of the system instances may yield an alternative system configuration. Selection of a new primary system instance for the application may come from one of the background system instances or from an alternative system configuration. Accordingly, the scope of protection of this invention is limited only by the following claims and their equivalents.

What is claimed is:

1. A method, comprising:
executing an application as a primary system instance;
executing, by a first system instance with a first configuration and a second system instance with a second configuration, the application associated with a set of data, the first and second instances executing as background processes;
generating, by a processor, first performance data associated with the first system instance and second performance data associated with the second system instance, and storing the first performance data at a first location and the second performance data at a second location;
comparing with the processor the first and second performance data;
selecting one of the first and second system instances responsive to the comparison;
converting the selected system instance to a new primary configuration; and
executing the application by the new primary system associated with the converted configuration.

2. The method of claim 1, further comprising the first system instance and second system instance executing the application in parallel.

3. The method of claim 2, further comprising generating first price data associated with the first system instance and second price data associated with the second system instance and comparing the first and second price data.

4. The method of claim 2, further comprising the second system instance writing data to a null pipe.

5. The method of claim 1, wherein the performance data is selected from the group consisting of: CPU utilization, I/O rates, disk usage, and combinations thereof.

6. The method of claim 1, wherein the first instance and second instance are selected from the group consisting of: a virtual machine and a container.

7. The method of claim 7, further comprising executing the application on a foreground system, and in parallel, executing the application as a background process on each of the first and second system instances, and generating performance data for each configured system instance, wherein the performance data includes an execution time threshold.

8. A computer system, comprising:
a processing unit operatively coupled to memory;
the processing unit to execute an application as a primary system instance;
a plurality of system instances, having at least two different hardware configurations, including a first system instance with a first hardware configuration and a second system instance with a second hardware configuration;
the first system and the second system instances to execute an application as background processes;
the processing unit to generate first performance data associated with the first instance and second performance data associated with the second instance;
a first memory location to store the first performance data and a second memory location to store the second performance data; and
evaluation of the first and second performance data by the processing unit, and conversion of one of the first and second system instances to a new primary configuration for execution of the application.

9. The computer system of claim 8, further comprising the first system and second system instances the application in parallel.

10. The computer system of claim 9, further comprising the processing unit to generate first price data associated with the first system instance and second price data associated with the second system instance and to compare the first and second price data.

11. The computer system of claim 9, further comprising the second system instance to write data to a null pipe.

12. The computer system of claim 8, wherein the performance data is selected from the group consisting of: CPU utilization, I/O rates, disk usage, and combinations thereof.

13. The computer system of claim 8, wherein the first and second instances are selected from the group consisting of: a virtual machine and a container.

14. The computer system of claim 13, further comprising the processing unit executing the application with the primary system instance on a foreground system, and in parallel executing the application as a background process on each of the first and second instances, and generating performance data for each configured system instance, wherein the performance data includes an execution time threshold.

15. A computer program product for system instance performance analysis, the computer program product comprising a computer readable storage device having computer readable program instructions embodied therewith, the program instructions executable by a processor to:
execute an application as a primary system instance;
execute, by a first system instance with a first configuration and a second system instance with a second configuration, the application as background processes;
generate first performance data associated with the first system instance and second performance data associated with the second system instance, and store the first data at a first location and the second data at a second location;
compare the first and second performance data;
select one of the instances responsive to the comparison; and
convert the selected instance to a new primary instance and execute the application by the new instance.

16. The computer program product of claim 15, further comprising the program instructions to execute, by the first instance and the second instance, the application in parallel.

17. The computer program product of claim 16, further comprising the program instructions to generate first price data associated with the first instance and second price data associated with the second instance and compare the first and second price data.

18. The computer program product of claim 16, further comprising the second instance to write data to a null pipe.

19. The computer program product of claim 15, wherein the first and second instances are selected from the group consisting of: a virtual machine and a container.

20. The computer program product of claim 15, wherein the primary instance executes as a foreground process and the first and second instances execute parallel to the primary instance as background processes.
